(19) United States
(12) Patent Application Publication
(10) Pub. No.: US 2006/0239761 A1
(43) Pub. Date: Oct. 26, 2006

(54) Pen

(76) Inventor: Carl Cetera, Tenafly, NJ (US)

Correspondence Address: THE SONI LAW FIRM, 55 S. LAKE AVE SUITE 720, PASADENA, CA, 91101, US

(21) Appl. No.: 11/112,271

(22) Filed: Apr. 21, 2005

(51) Int. Cl. B43K 1/10; B43K 5/16

(52) U.S. Cl. 401/258; 401/195; 401/111; 401/37

(57) ABSTRACT

An hand held elongated implement with a retractable tip at one end and a stylus point at the opposite end. The implement incorporates a retraction and extension means by which pressure need not be applied to the stylus tip for actuation but rather, retraction or extension is accomplished by the application of generally downward force upon the sloping sides of the implement proximate the stylus end. The implement may further include a clip which serves many purposes, including the providing of a curved surface on which said downward force may be comfortably applied and the providing of a contoured surface upon which the user may comfortably rest their thumb or forefinger when the implement is used in its inverted position as a stylus point instrument.

### FIELD OF THE INVENTION

The present invention is directed to a writing implement in combination with a stylus tip opposite the writing tip. More precisely, the invention involves an externally actuated retraction implement because the pointed stylus tip resides in the upper terminus of the implement, rendering the implement ill suited for the application of thumb pressure upon this tip. The invention is directed to an alternate retraction means whereby a spring loaded writing tip may be extracted or retracted by application of downward axial pressure upon the curved outer surface of the implement body and/or the optionally attached clip.

### BACKGROUND OF THE INVENTION

Writing instruments incorporating both a stylus tip and a ball point pen have been previously described. Hazzard, in U.S. Pat. Nos. 5,913,629; 6,050,735; D402,690; and D424,112 discloses writing instruments with a ball point pen tip capable of projecting out from under a fixed stylus tip when the ball point mechanism is actuated. Hazzard does not describe a stylus tip located on the end of the implement opposite the writing tip.

A combination of a stylus tip and a pocket clip mounted on the cap of a writing instrument is described by Haffner in U.S. Pat. No. 6,659,673. In that invention, there is a slidable member functioning as a pocket clip on one end and as a stylus on the other end. The disadvantage of this device is that the cap must be removed to get access to the ball point pen tip. In addition, the cap with its integral stylus point can be lost or misplaced. Finally, the pocket clip end is pointed, narrow, and fragile.

Retractable tip writing implements have long been known in the art, however, these implements utilize a far different mechanism than would be viable with a stylus tip device. For example, U.S. Pat. No. 3,189,282, to Schultz, describes a basic retractable device having a push button top as is most commonly used in the pen industry. This type of device is lacking, however, in that it relies upon a tip mounted push button for actuation.

Similarly, U.S. Pat. No. 3,679,318 to Liguori and U.S. Pat. No. 3,920,337 to Ganz describe alternate methods for retraction and extension of a writing tip. The Ganz design relies upon a pivoting clip, one end of which is pressed radially inward to actuate mating cams for retraction/extension, while the Liguori design utilizes a rotating upper piece to actuate a cam ramp to extend or retract the ink tip. Each of these designs, however utilizes a complicated cam design and neither invention incorporates a functional stylus tip or stiff contoured clip which would be required to achieve a working stylus designed product.

What is lacking in the existing art is a combination implement with a stylus point on one end and a writing tip on the opposite, whereby the user may quickly and easily use of the stylus and writing tips without manipulating the implement. Such a combination would allow the user to readily switch back and forth from writing with a ball point tip to using the stylus without the necessity of actuating the ball point pen writing mechanism nor removing a pen cap. What is lacking by association to the above contemplated device is a means for retraction or extension of the writing tip of the implement without the user having to press directly upon the pointed stylus tip or to include a pivoting, and therefore flimsy, clip member.

### SUMMARY OF THE INVENTION

An object of the present invention to provide a combination device comprising a writing implement and a “PDA” type stylus, wherein said device may be used within an comfortable elongated writing instrument. The present invention will provide a combination device comprising an implement and a PDA stylus, wherein the stylus is permanently mounted and is broad and sturdy.

Still another object of this invention is to provide a combination device comprising a clip and a PDA stylus, wherein said PDA device could be placed on an exposed part of a writing instrument other than the cap. Accordingly, the present invention provides a combination device comprising a writing tip and a PDA stylus, wherein said stylus is easily deployed at the end of the implement. Moreover, the present invention may include a contoured clip upon which the user may rest their thumb when using the stylus point to operate a personal data assistant device.

Lastly, an object of the present invention is top provide a retractable tip implement having a spring retraction means whereby the user need not assert pressure directly upon the pointed stylus end of the implement to retract or extend the implement tip.

The objects of this invention are accomplished by providing a multifunction handheld writing instrument includes a combination device of a writing implement and a resiliently mounted stylus. The practical use of this implement necessitates an alternative method by which the retractable writing tip may be extended and retracted. In a conventional device, the user exerts downward axial thumb pressure upon the push button located at the implement end opposite the writing tip. Since the present invention incorporates a pointed stylus tip as its end configuration, however, application of thumb pressure upon this pointed stylus would be neither comfortable nor desirable. Thus, the present invention further comprises an external spring and actuation means which actuates the more conventional spring loaded extension/retraction of the writing tip. Replacing the push button mechanism with an external retraction eliminates the need for application of thumb pressure to the pointed stylus tip.

The external retraction mechanism allows the user to circumferentially grasp the clip end of the implement and assert axial pressure upon the outer surface of the clip end, or preferably, upon the clip at its contoured surface.

### BRIEF DESCRIPTION OF THE DRAWINGS

These and other aspects of the invention will now be described with reference to the accompanying drawings, in which:

FIG. 1 is a perspective view of the present invention showing the body, clip, stylus point and the orifice through which an implement tip may project.

FIG. 2 is a side view of the present invention showing its main components and also showing the contoured profile of the clip.

FIG. 3 is a side cross sectional view of the present invention to reveal the internal and external spring mechanisms used in the device.

FIG. 4 is an exploded view of the present invention which shows each of the components oriented in a similar side view position.

### DETAILED DESCRIPTION OF THE INVENTION

The accompanying Figures depict embodiments of the present invention, and features and components thereof. With regard to means for fastening, mounting, attaching or connecting the components of the present invention to form the apparatus as a whole, unless specifically described otherwise, such means are intended to at least encompass conventional fasteners such as machine screws, machine threads, snap rings, hose clamps such as screw clamps and the like, rivets, nuts and bolts, toggles, pins and the like. Components may also be connected by friction fitting, snap fitting, adhesives, or by welding or deformation, if appropriate. Unless specifically otherwise disclosed or taught, materials for making components of the present invention are selected from appropriate materials such as metal, metallic alloys, natural or synthetic fibers, plastics and the like, and appropriate manufacturing or production methods including casting, extruding, injection molding and machining may be used.

Any references to front and back, right and left, medial and lateral, top and bottom, upper and lower, superior and inferior, and horizontal and vertical are intended for convenience of description, not to limit the present invention or its components to any one positional or spacial orientation.

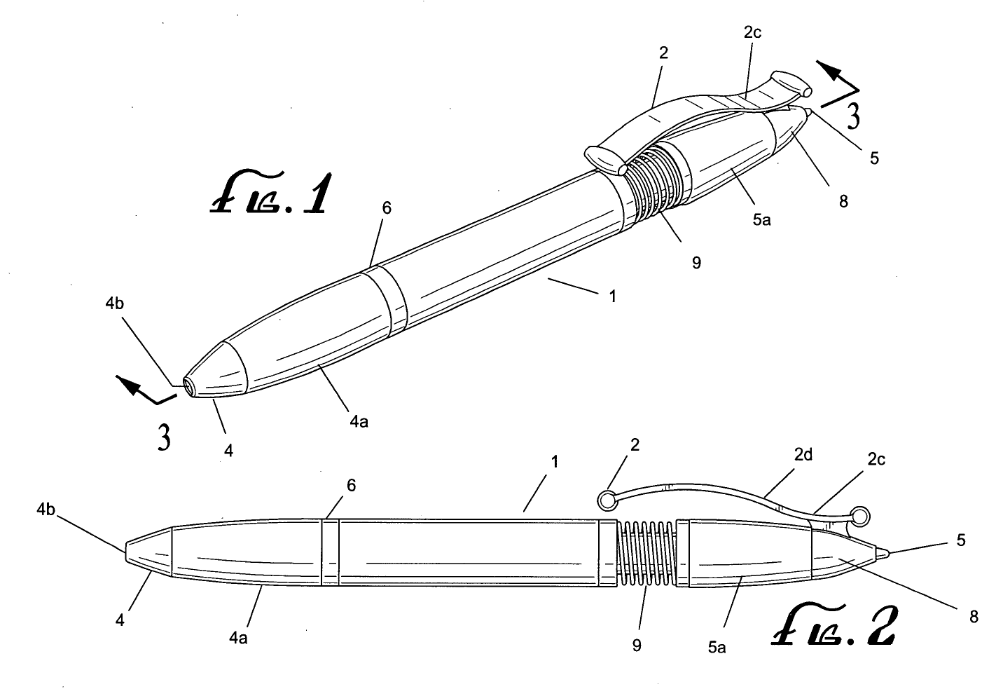

Referring more specifically to the drawings, there is shown in FIGS. 1 and 2, a preferred embodiment of the present invention in the configuration of a handheld writing implement. The handheld writing implement in the preferred embodiment is a pen. The writing implement body comprises a barrel 1, extending from an implement tip 4 to a stylus tip 5, and may include optional compressible grips 4a and 5a. As shown in FIGS. 1, 3 and 4, the barrel 1 of the preferred embodiment includes three main structural components, the lower end 6, the mid body 7 and the stylus end 8. In the preferred embodiment, these three components are joined by means of threaded connections 7a and 7b. In the preferred embodiment, the implement further includes a clip 2, and an actuator means 3. While the preferred embodiment comprises three distinct components, the invention may be accomplished by more or less than three pieces, so long as the retraction mechanism and writing refill, in this case an ink refill, may be encapsulated within the barrel structure. While the drawings depict threaded connections 7a and 7b between the three components, the invention may be accomplished by any practical means by which the components may be connected, such as adhesive, interference fits, pins and other joining methods.

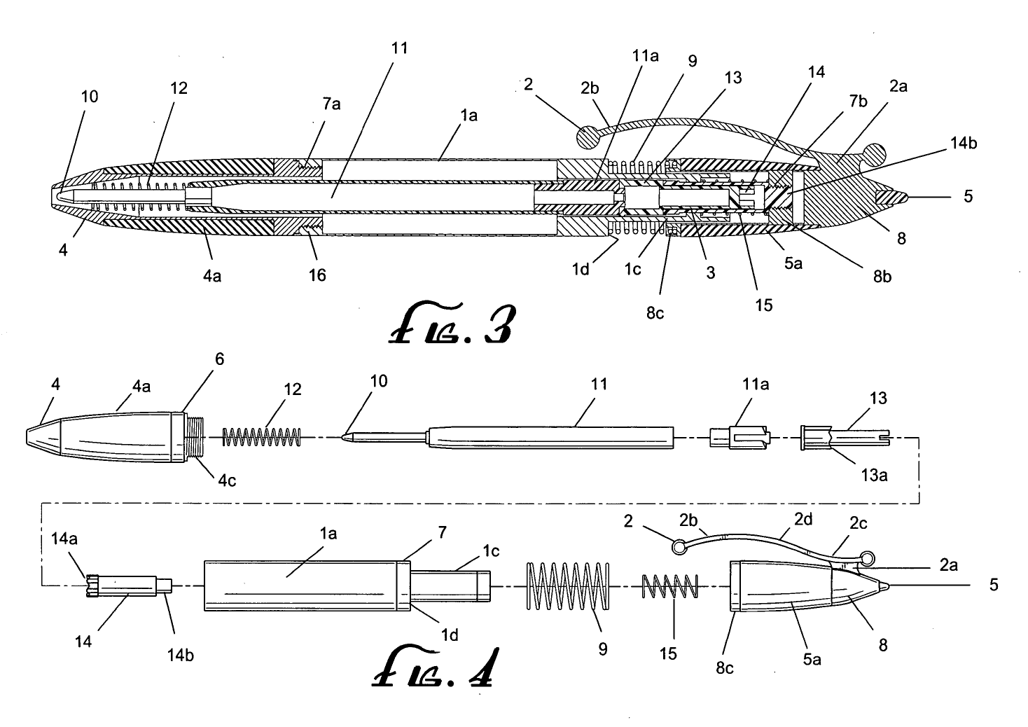

Again referring to FIGS. 3 and 4, it can be seen that the lower end 6 of the implement in the preferred embodiment includes a compressible grip 4a, which the user would grasp between thumb and forefinger for use of the implement as a writing tip. This grip 4a is mounted on the outer circumference of the single piece lower end 6 which forms the implement tip 4 and orifice 4b at one end and the male threaded mounting flange 4c at the opposite end. Similarly, the stylus end 8 further comprises a stylus tip 5, a contoured clip 2 and a compressible grip 8a which resides radially outward of the single piece stylus end 8. This stylus end 8 incorporates a coaxial female inner threaded portion 8b, which serves to unitize the assembly as described in greater detail below.

The barrel 1, as depicted in FIGS. 3 and 4, comprises a generally cylindrical body 1a with female coaxial threads 1b inside its lower end and a reduced diameter extension 1c at its opposite end. An external spring 9 resides radially outward from outer surface of the extension 1c and is compressible between the ring shoulder 1d of the body 1a and a retention ring 8c as the writing tip 10 is retracted or extended.

Referring to FIGS. 3 and 4, in the preferred embodiment, a standard ink refill 11 resides within the barrel 1 and includes the writing tip 10 and a typical retraction spring 12. The inboard end of the refill 11 has a cap 11a, which is inserted shallowly into a plunger 13 which has ratchet engagement points 13a about its outer circumference. This plunger 13, is inserted into a pawl shaft 14 which incorporates prongs 14a about its bottom circumference. These prongs 14a engage the points 13a in this spring loaded retraction means to alternatively retract or extend the writing tip 10 upon downward pressure applied to the compressible grip 8a, as discussed below.

To assemble the preferred embodiment of the implement, the refill 11 and retraction spring 12 are inserted into the lower end 6. The plunger 13 is inserted into the pawl shaft 14 and this sub assembly is then placed upon the inboard end of the refill 11. The cylindrical body 1a is then slid over the pawl shaft 14, plunger 13 and refill 11 to rotatably engage the threaded connection between the body 1a and the lower end 6 to form the assembly. At this point in the assembly, the partially assembled device is a working implement as pressing upon the pawl shaft 14 displaces and rotates the plunger 13 by means of the engagement between the prongs 14a and points 13a. The retraction spring 12 maintains the compression force upon these components to complete the retraction and extension action much the same as any conventional retraction pen would function. This retraction/extension actuation is well known to those skilled in the art.

A main object of this invention, however, to facilitate retraction and extension without pressure upon the stylus tip 5 is accomplished by the stylus end 8 components' interaction with the refill 11, pawl shaft 14 and associated components.

As shown in FIG. 3, the reduced diameter extension 1c of the cylindrical body 1a further comprises an internal shoulder 1d which is dimensioned such that the pawl shaft 14 end may protrude axially outward from the body 1a but the pawl shaft main portion will be retained within the body 1a by the shoulder 1d. Male threads 14b are formed on the protruding end of the pawl shaft 14. The coaxial female inner threaded portion 8b of the stylus end 8 will be threaded onto these male threads 14b so as to join the stylus end 8 to the main body 1a. In order to stiffen the retraction mechanism of the preferred embodiment, an external spring 9 would be utilized. The external spring 9 resides radially outward from outer surface of the extension 1c and is compressible between the ring shoulder 1d of the body 1a and a retention ring 8c as the writing tip 10 is retracted or extended. This compression force stiffens the retraction mechanism to ensure the components all return to their original position following release of thumb pressure of retraction or extension of the writing tip. In addition to the external spring 9, an internal spring 15 may be employed, which fits over the protruding portion of the pawl shaft 14 and is similarly compressed by tightening the threaded portion 8b onto the male threads 14b.

Lastly, as shown in FIGS. 1 through 4, the preferred embodiment further comprises a clip 2 with which the implement may be attached to another article, such as the user's shirt pocket. The clip 2 includes a mounting support 2a and a contoured member 2b. This contoured member 2b is designed for comfort when the user has the pen gripped in an inverted orientation. In so doing, the user has elected to use the stylus tip 5 as the working implement. In this position, the user places his thumb or forefinger on the concavely sloping portion 2c of the contoured member 2b. This allows the user to maintain a firm grip on the implement for stylus use and it further facilitates repetitive and lengthy use of the stylus point 5 without pain, discomfort or fatigue on the user's hand or digits.

This contoured clip 2 also serves the purpose of presenting a comfortable surface which is contoured properly to facilitate the pressure point for actuation of the retraction means for the retraction and extension of the writing tip 10. By gripping the clip 2 at its concavely sloping portion 2c and applying downward axial pressure against the convexly curved portion 2d of the clip 2, the user may actuate the retraction mechanism described above. In so doing, the user is not forced to apply downward axial pressure directly upon the rather sharply pointed stylus tip 5. Thus, the goal of having a working implement with an ever present stylus point concurrently with a retraction means is achieved.

While the preferred embodiment describes a writing implement, the scope of the contemplated invention is not so limited. Examples of implements contemplated within the scope of the present invention include writing implements such a pens and pencils, laser pointers, conventional pointers, cutting implements such as knives, awls and scribes, and other hand-held retractable implements such as brushes, cosmetics applicators, soldering devices and computer styluses.

It should also be noted that the outer surfaces of the hand held implement, having relatively smooth surfaces, are well-suited for application of art work, logos and graphics for advertising and promotional purposes.

What is claimed is:

1. A retractable tip hand held implement having an elongated implement body, an implement tip end, a stylus end and a retraction means;
said stylus end having a generally conical shape terminating in a point located at the end of the body opposite the implement tip end; and
said retraction means capable of being actuated by the application of a generally downward axial force upon the conical sides of the stylus end proximate the point.

2. The implement of claim 1 whereby the retraction means further comprises a spring located radially outside of an elongated implement body.

3. The implement of claim 1, wherein said hand-held implement is selected from the group consisting of a writing instrument, a laser pointer, a multi-function writing instrument, a screwdriver, and a tire pressure gauge.

4. The hand held implement of claim 1 further including a writing tip which is selected from the group consisting of: ink pen, pencil, highlighter and marker.

5. The hand held implement of claim 1, whereby at least one of the implement tip and stylus ends further comprises a cushioned grip surface.

6. The hand held implement of claim 1, wherein graphical or advertising material is imprinted on at least one surface for the purpose of providing advertising or promotion.

7. The hand held implement of claim 1 whereby the implement further comprises at least one contoured clip attached to the implement body.

8. The hand held implement of claim 7 whereby the clip is contoured and curved such that the user's thumb may rest on an inwardly curved portion of the clip outer surface when using the stylus point end of the implement.

9. The hand held implement of claim 7 whereby the clip is contoured and curved such that the user's thumb may press upon an inwardly curved portion of the clip outer surface to serve as a point of application of downward axial pressure on the stylus end to actuate the retraction or extension of the implement tip.

10. A hand held implement comprising a first end, a second end, a body, a retraction mechanism and a clip;
said first end being an elongated barrel shape and having an orifice through which a writing tip may extend and retract with the inboard end of the writing tip affixed to a writing media refill cartridge;
said second end being an elongated shape terminating at a stylus point positioned opposite the first end orifice in the assembled implement;
said body having a generally tubular shape in which a media refill cartridge may reside and translate axially as the writing tip is extended or retracted;
said retraction mechanism including a spring radially displaced externally to the body and surrounding an attachment point of one end to the body, and serving to extend or alternatively retract said media shaft and writing tip by means of a spring loaded retraction mechanism, actuated by an application of axial compressive force upon the second end proximate to but not upon the stylus tip; and
said clip comprising a contoured outer surface which is curved such that the user's thumb may rest upon an inwardly curved portion of said outer surface when using the stylus end of the implement.

11. The hand held implement of claim 10 whereby the writing tip is selected from the group consisting of: ink pen, pencil, highlighter, marker, laser pointer.

12. The hand held implement of claim 10, whereby at least one of the first and second ends further comprises a cushioned grip surface.

13. The hand held implement is claim 10, whereby at least one of the first end and the second end is attached to the body by coaxial threaded connection.

14. The hand held tip of claim 10, wherein graphical or advertising material is imprinted on at least one surface for the purpose of providing advertising or promotion.

15. A method of advertising or promotion whereby graphical or advertising material is imprinted on at least one surface of a hand held implement hand held implement having a first end, a second end, a body, a retraction mechanism and a clip;
said first end being an elongated barrel shape and having an orifice through which a writing tip may extend and retract with the inboard end of the writing tip affixed to a writing media refill cartridge;
said second end being an elongated shape terminating at a stylus point positioned opposite the first end orifice in the assembled implement;
said body having a generally tubular shape in which a media refill cartridge may reside and translate axially as the writing tip is extended or retracted;
said retraction mechanism including a spring radially displaced externally to the body and surrounding an attachment point of one end to the body, and serving to extend or alternatively retract said media shaft and writing tip by means of a spring loaded retraction mechanism, actuated by an application of axial compressive force upon the second end proximate to but not upon the stylus tip; and
said clip comprising a contoured outer surface which is curved such that the user's thumb may rest upon an inwardly curved portion of said outer surface when using the stylus end of the implement.
